(19) United States
(12) Patent Application Publication
(10) Pub. No.: US 2010/0287052 A1
(43) Pub. Date: Nov. 11, 2010

(54) Short-range commercial messaging and advertising system and mobile device for use therein

(76) Inventors: David D. Minter, Littleton, CO (US); Albert S. Baldocchi, Boulder, CO (US)

Correspondence Address: Scot A. Reader, Esq., Suite 228, 1320 Pearl Street, Boulder, CO, 80302, US

(21) Appl. No.: 12/589,401

(22) Filed: Oct. 22, 2009

Related U.S. Application Data
(60) Provisional application No. 61/215,532, filed on May 6, 2009.

(51) Int. Cl. G06Q 30/00; H04B 7/00

(52) U.S. Cl. 705/14.64; 455/41.2; 705/14.66

(57) ABSTRACT

Short-range commercial messaging and advertising systems and mobile devices for use therein allow merchants to deliver advertising over wireless networks to mobile devices operated by roaming consumers who are in the vicinity of the merchant. A distinguishing feature of the systems and mobile devices is that they eliminate traditional advertising intermediaries, such as television, radio and Internet networks, allowing businesses to advertise directly to consumers at dramatically lower costs relative to traditional advertising.

### CROSS REFERENCE TO RELATED APPLICATION(S)

This application claims the benefit of U.S. provisional application No. 61/215,532 entitled “Method and System for Short-Range Messaging,” filed on May 6, 2009, which is incorporated herein by reference.

### BACKGROUND OF THE INVENTION

The present invention relates to short-range commercial messaging and, in some embodiments, delivering point of sale advertising over wireless networks to mobile devices operated by roaming consumers who are in the vicinity of the point of sale.

The local advertising market is undergoing dramatic change as traditional channels for advertising wane in influence. Newspapers thrived for generations by bundling advertising with print news. However, newspaper circulation has steadily declined as the Internet has attracted newsreaders with its breadth, depth and timeliness of coverage. At the same time, classified ads that were integral to newspaper profitability have been increasingly redirected to free Internet websites such as Craigslist. As newspaper circulation and advertising revenue have plummeted, some newspapers have gone out of business and the value of advertising in many others has diminished.

Paper telephone directories (e.g. Yellow Pages) were once another popular channel for advertising. However, use of such directories has decreased as consumers have migrated to the Internet to find goods and services. Thus, the traditional Yellow Page ad has become less effective.

The reduced value proposition offered by these traditional channels for advertising has led merchants to seek new, cost-effective alternatives to reach local consumers. The Internet may eventually provide a compelling solution, but today's search engines (e.g. Google), online directories (e.g. Dex) and rating services (e.g. Yelp) have not yet managed to deliver information in a way that adequately benefits local merchants. Meanwhile, many merchants have deployed short-range wireless networks (e.g. Institute of Electrical and Electronics Engineers Standard 802.11 “Wi-Fi” networks) in their establishments to provide their employees and sometimes their customers who possess portable devices, such as cell phones, iPhones, personal data assistants (PDA) and notebook computers, with access to the Internet.

### SUMMARY OF THE INVENTION

The present invention provides for short-range commercial messaging systems and devices for use therein that allow merchants to deliver advertising over wireless networks to mobile devices operated by roaming consumers who are in the vicinity of the merchant. The invention offers significant advantages relative to local advertising via traditional channels. First, the invention can leverage technology already deployed for other purposes (e.g. Wi-Fi networks installed at points of sale and Wi-Fi-enabled mobile devices operated by roaming consumers). Second, the invention can operate direct from merchant to consumer. The absence of an intermediate commercial entity (e.g. television broadcaster, radio broadcaster, Internet service provider, newspaper publisher, paper telephone directory publisher, search engine company, other web-based companies) minimizes cost and maximizes control over message content and distribution. Third, the geographic screen implicit in short-range messaging means that advertising is delivered only to consumers who are at or near the merchant. This increases the likelihood that the consumers who receive the advertising will be motivated to act on it because consumers tend to shop in places that are geographically nearby and convenient.

In one aspect, the invention addresses methods and systems by which a message source controlled by a merchant selects a short-range commercial message for delivery to a mobile device operated by a roaming consumer. The likelihood that a roaming consumer will act on a short-range commercial message can be improved by choosing a message mindful of particular attributes and circumstances of the roaming consumer and his or her mobile device. For example, a roaming consumer may be a commuter rushing to work in a car or a pedestrian walking down a street at a leisurely pace. Accordingly, methods and systems that allow a message source to select a short-range commercial message based on such particular attributes and circumstances are advantageous. In some embodiments of the invention, the message source selects a short-range commercial message based on one or more of the following: (a) identity of the mobile device, (b) identity of the roaming consumer, (c) connection history of the mobile device, (d) connection history of the roaming consumer, or (e) indication of strength of the network signal. In some embodiments, the message source selects between a short-range commercial message comprising content and a short-range commercial message comprising a Web link to the content based on an indication of strength of the network signal.

In another aspect, the invention addresses methods and systems by which a message source controlled by a merchant delivers a short-range commercial message to a mobile device operated by a roaming consumer. A mobile device typically has processing and storage constraints. Additionally, at a given time there may be competition for a mobile device among multiple wireless networks that have short-range commercial messages to deliver. Accordingly, methods and systems that allow a mobile device to make an early decision regarding admission and output status of a short-range commercial message (e.g. discard, cache for later outputting, output immediately) are advantageous. In some embodiments of the invention, a short-range commercial message has a descriptive tag whose delivery precedes associated content and the mobile device analyzes the descriptive tag to determine admission and output status of the message. In some embodiments, the descriptive tag comprises one or more of the following message attributes: (a) merchant identity, (b) merchant type, (c) content type, (d) product type, or (e) financial inducement. In some embodiments, the message source resides within a merchant establishment that has connectivity to the roaming consumer independent of the Internet. In some embodiments, the descriptive tag comprises a Web link to content, wherein the Web link is stored on the mobile device and is retrievable by a roaming consumer at a later time to access the content via the Internet.

In yet another aspect, the invention addresses methods and systems by which a mobile device operated by a roaming consumer processes a short-range commercial message received from a message source controlled by a merchant.

Roaming consumers have highly diverse preferences and limited time. Accordingly, methods and systems that determine admission and output status of a short-range commercial message based on predetermined policies operative on the mobile device are advantageous. In some embodiments of the invention, a mobile device determines admission and output status of a short-range commercial message based on one or more of the following predetermined policies: (a) merchant identity, (b) merchant type, (c) content type, (d) product type, or (e) financial inducement. In other embodiments, a mobile device may determine admission and output status of a short-range commercial message based on real-time consumer input.

In yet another aspect, the invention addresses methods and systems by which a mobile device operated by a roaming consumer receives short-range commercial messages from multiple wireless networks controlled by different merchants. Widespread and largely unregulated deployment of short-range wireless networks means that at a given time a mobile device operated by a roaming consumer may simultaneously be within range of multiple wireless networks that want to deliver a short-range commercial message. Accordingly, methods and systems that allow a mobile device to receive short-range commercial messages from multiple wireless networks in an orderly and efficient way are advantageous. In some embodiments of the invention, a mobile device connects to the networks sequentially, wherein the sequence is determined based on network signal strength, and receives short-range commercial messages while connected to the networks. In other embodiments, a mobile device receives short-range commercial messages attendant to discovery of the networks, without having to connect to the networks. In still other embodiments, a mobile device is equipped to manage multiple concurrent network connections and connects to and receives the short-range commercial messages from the networks contemporaneously.

These and other aspects of the invention will be better understood by reference to the detailed description of a preferred embodiment taken in conjunction with the drawings briefly described below. Of course, the scope of the invention is defined by the appended claims.

### BRIEF DESCRIPTION OF THE DRAWINGS

FIG. 1 shows a communication system in some embodiments of the invention.

FIG. 2 shows a mobile device in some embodiments of the invention.

FIG. 3 shows functional elements of the mobile device of FIG. 2.

FIG. 4 shows a message source in some embodiments of the invention.

FIG. 5 shows functional elements of the message source of FIG. 4.

FIG. 6A shows a short-range commercial message in some embodiments of the invention.

FIG. 6B shows a short-range commercial message and associated content in some embodiments of the invention.

FIG. 7 shows a method by which a mobile device receives short-range commercial messages from multiple wireless networks in some embodiments of the invention.

FIG. 8 shows a method by which a mobile device processes a short-range commercial message received from a message source in some embodiments of the invention.

FIG. 9 shows a method by which a message source selects a short-range commercial message for delivery to a mobile device in some embodiments of the invention.

### DETAILED DESCRIPTION OF A PREFERRED EMBODIMENT

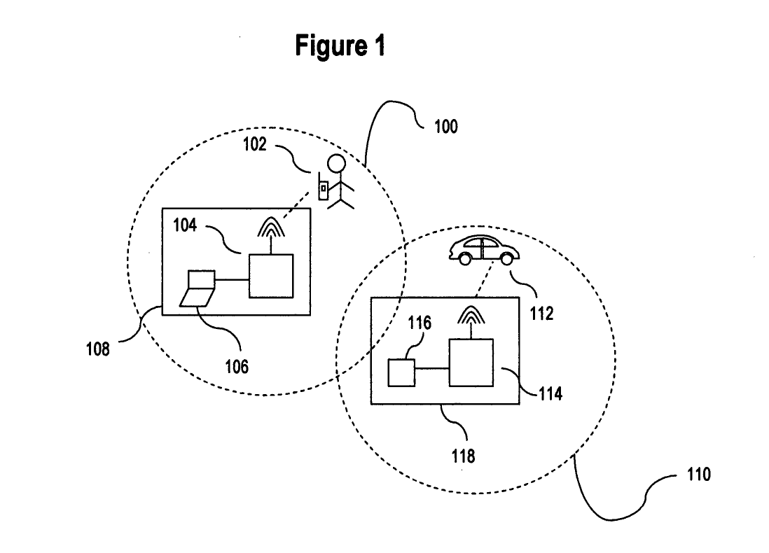

FIG. 1 shows a communication system in some embodiments of the invention. The communication system includes a first merchant network having a coverage area 100 that provides a wireless access range of about 50 to 500 feet and a second merchant network having a coverage area 110 that provides a similar wireless access range. The first merchant network has a base station 104 deployed within a first merchant establishment 108. Base station 104 has a wireless connection to a mobile device 102 operated by a roaming consumer and a wired connection to a message source 106 disposed within first merchant establishment 108. The wired connection between base station 104 and message source 106 consists of one or more local area network (LAN) segments and does not traverse the Internet. The second merchant network has a base station 114 deployed within a second merchant establishment 118. Base station 114 has a wireless connection to a mobile device 112 operated by a roaming consumer and a wired connection to a message source 116 disposed within second merchant establishment 118. The wired connection between base station 114 and message source 116 consists of one or more LAN segments and does not traverse the Internet. Base stations 104, 114 may or may not have wired connections to the Internet. Coverage areas 100, 110 partially overlap, such that a roaming consumer and his or her mobile device may be within both coverage areas simultaneously. While in the illustrated embodiments the base station and message source are shown as discrete network nodes, in other embodiments the base station and the message source may be combined in a single network node.

Mobile device 102 is a wireless handset that has wireless networking capability. Mobile device 102 may be any of various wireless handset types, such as a cell phone, smart phone or PDA. Mobile device 112 is a vehicle that has wireless networking capability. Mobile device 112 may be any of various vehicle types, such as a car, truck, bus, sport utility vehicle or motorcycle. In some embodiments, mobile devices 102, 112 are Wi-Fi capable, although in other embodiments mobile devices may support an additional or different wireless networking protocol, such as Bluetooth or radio frequency identification (RFID).

Base stations 104, 114 are wireless network access points. In some embodiments, base stations 104, 114 are Wi-Fi access points, although in other embodiments base stations may support a different wireless networking protocol, such as Bluetooth or RFID.

Message source 106 is a personal computer capable of selecting and retrieving advertising content from an internal content store and delivering to mobile device 102 a short-range commercial message having associated advertising content. Message source 116 is a content server capable of selecting and retrieving advertising content from an internal content store and delivering to mobile device 112 a short-range commercial message having associated advertising content. As mentioned, while message sources 106, 116 are shown as independent network nodes, in some embodiments a message source may be integral with a base station. In other embodiments, a message source may retrieve advertising content from a remote storage facility, which may or may not be accessed over the Internet.

Merchant establishments 108, 118 are physical points for conducting business. A merchant establishment may be permanent, such as a “bricks and mortar” retail outlet, business office or sports stadium, or temporary, such as a trade show booth or exhibition kiosk.

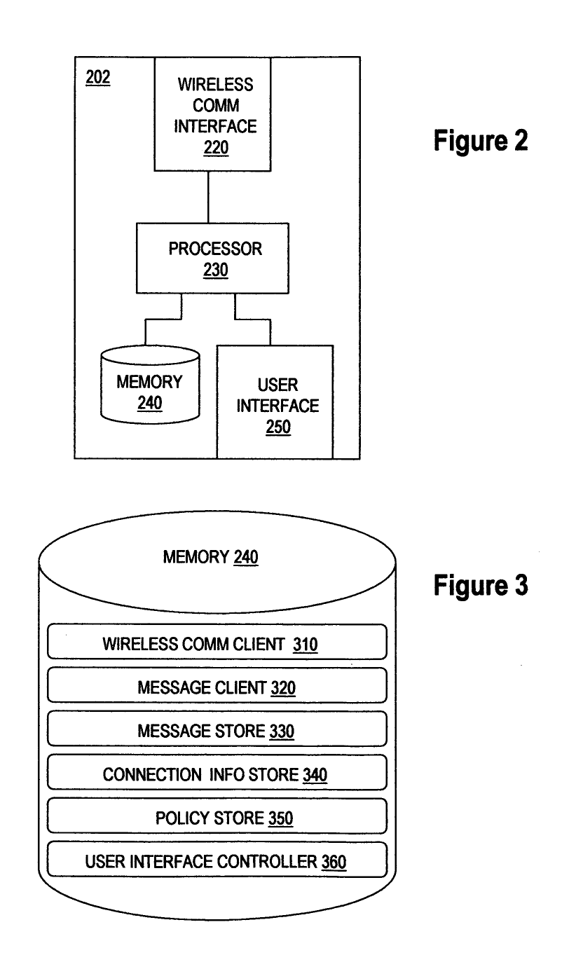

FIG. 2 shows a mobile device 202 in some embodiments of the invention. Mobile device 202 includes a wireless communication interface 220, a memory 240 and a user interface 250, all of which are communicatively coupled with a processor 230. Wireless communication interface 220 transmits and receives information over wireless connections established with base stations. Processor 230 executes software that performs functions and features supported by mobile device 202. Memory 240 includes one or more random access memory (RAM) elements and one or more read-only memory (ROM) elements or other type of memory that store software and information applied in support of functions and features supported by mobile device 202. User interface 250 has one or more input mechanisms, such as a touch screen, keypad, keyboard and/or microphone for receiving inputs from a roaming consumer who operates mobile device 202 and one or more output mechanisms, such as a display screen and/or loudspeaker, for providing outputs to the roaming consumer.

FIG. 3 shows functional elements of mobile device 202 stored in memory 240. Wireless communication client 310 is a software element executed under control of processor 230 that discovers short-range wireless networks and establishes and manages wireless connections with base stations via wireless communication interface 220. Where mobile device 202 is simultaneously within range of multiple wireless networks that want to deliver short-range commercial messages, wireless communication client 310 arranges for mobile device 202 to receive the short-range commercial messages in an orderly and efficient way.

Message client 320 is a software element executed under control of processor 230 that responds to requests received from message sources for information, determines admission and output status of short-range commercial messages received from message sources and manages storage and retrieval from memory 240 of information, admitted short-range commercial messages and policies applied in determining admission and output status of short-range commercial messages.

Message store 330 is a data facility that stores short-range commercial messages received from message sources and admitted by message client 320.

Connection information store 340 is a data facility that stores mobile device information, user information and/or network signal strength information. Mobile device information includes, by way of example, a unique device identifier and/or device model information. User information includes, by way of example, a unique user name. Network signal strength information includes, by way of example, a received signal strength indication (RSSI) received from a particular network.

Policy store 350 is a data facility that stores policies applied by message client 320 in determining admission and output status of short-range commercial messages. Policies include, by way of example, merchant identities, merchant types, content types, product types and/or financial inducements that are authorized or unauthorized and/or have a particular priority. Policies may additionally or alternatively include blanket policies, such as an absorption policy in which all short-range commercial messages are admitted and cached for later outputting; or a policy in which short-range commercial messages comprising Web links to content are admitted and cached but short-range commercial message comprising the content are not.

User interface controller 360 is a software element executed under control of processor 230 that manages via user interface 250 interactions with a roaming consumer who operates mobile device 202. Such interactions include receiving as inputs on user interface 250 mobile device and/or user information and policies applied in determining admission and output status of short-range commercial messages, and outputting on user interface 250 short-range commercial messages and/or content associated with short-range commercial messages.

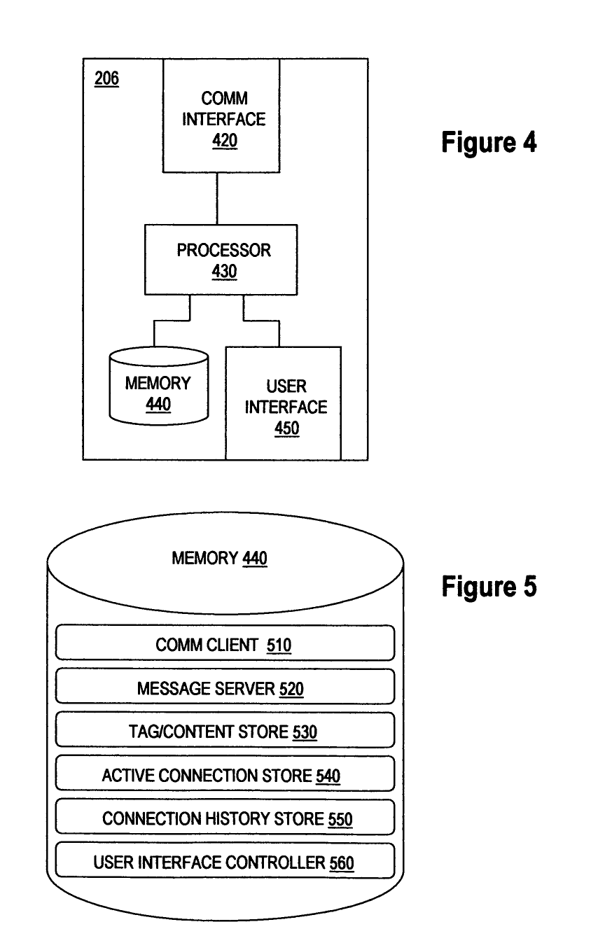

FIG. 4 shows a message source 206 in some embodiments of the invention. Message source 206 includes a communication interface 420, a memory 440 and a user interface 450, all of which are communicatively coupled with a processor 430. Communication interface 420 is a wired or wireless communication interface that transmits and receives information from mobile devices over a connection established with a base station. Processor 430 executes software that performs functions and features supported by message source 206. Memory 440 includes one or more memory elements that store the software and information applied in support of functions and features supported by message source 206. User interface 450 has one or more input mechanisms, such as a touch screen, keypad, keyboard and/or microphone for receiving inputs from the merchant who operates message source 206 and one or more output mechanisms, such as a display screen and/or loudspeaker, for providing outputs to the merchant.

FIG. 5 shows functional elements of message source 206 stored in memory 440. Communication client 510 is a software element executed under control of processor 430 that manages a wired or wireless connection with a base station via communication interface 420.

Message server 520 is a software element executed under control of processor 430 that issues requests to mobile devices on active connections for mobile device information, user information and/or network signal strength information, stores information received from mobile devices in response to the requests in active connection store 540, generates and stores historical connection information for mobile devices in connection history store 550, selects short-range commercial messages for delivery to mobile devices on active connections based on received mobile device information, user information and/or network signal strength information, and issues short-range commercial messages to mobile devices.

Tag/content store 530 is a data facility that stores tags selectable by message server 520 for inclusion in short-range commercial messages delivered to mobile devices and content selectable by message server 520 for association with short-range commercial messages delivered to mobile devices. Tags include, by way of example, keywords that describe content, numerical content descriptors having standard definitions and Web links [(e.g. Uniform Resource Locators (URL)]. Content includes, by way of example, video files, audio files, Web pages, short text messages, bar codes and banner ads. Numerous discrete instances of content are stored in tag/content store 530, enabling short-range commercial message content to be individually tailored to roaming consumers and their mobile devices based on their particular attributes and circumstances.

Active connection store 540 is a data facility that stores mobile device information, user information and network signal strength information for active connections applicable by message server 520 in determining the format and associated content of short-range commercial messages. Mobile device information includes, by way of example, a unique device identifier and/or device model information. User information includes, by way of example, a unique user name. Network signal strength information includes, by way of example, a RSSI received from a particular mobile device.

Connection history store 550 is a data facility that stores historical connection information applicable by message server 520 in determining the format and associated content of short-range commercial messages. Historical connection information includes, by way of example, an historical record of times, durations and signal strengths of connections with and short-range commercial messages transmitted to particular mobile devices.

User interface controller 560 is a software element executed under control of processor 430 that manages interactions with a merchant who controls content source 206 via user interface 450. Such interactions include receiving on user interface 450 content selectable by message server 520 for association with short-range commercial messages delivered to mobile devices.

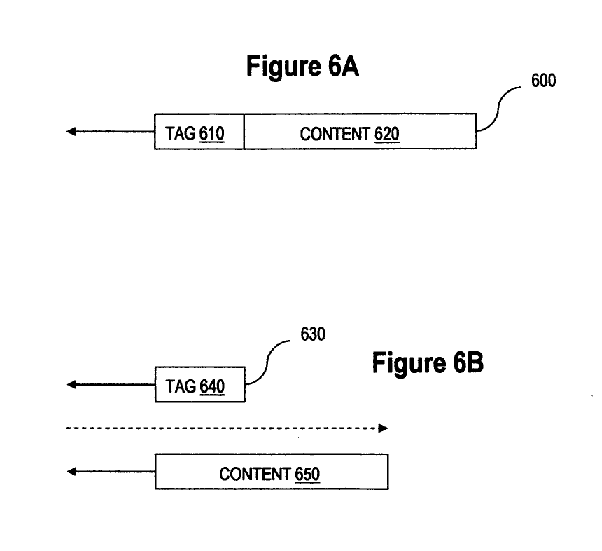

FIG. 6A shows a short-range commercial message 600 in some embodiments of the invention. In these embodiments, message 600 selected by message server 520 and delivered to a mobile device includes a descriptive tag 610 and associated content 620 that are bundled. Tag 610 is in the form of a header that precedes content 620. For example, content 620 may be a 30-second video advertisement preceded immediately by a tag 610 that includes words or numerical descriptors that describe the advertisement, such as the identity of the merchant who is sourcing the content (e.g. Joe's Coffee House), the type of merchant who is sourcing the content (e.g. food/beverage outlet), the type of content (e.g. video file), the type of product or service being advertised (e.g. coffee) and/or the financial inducement being offered (e.g. free coffee with any food purchase). The mobile device may determine admission and output status of message 600 by comparing tag 610 with predetermined policies stored on the mobile device.

FIG. 6B shows a short-range commercial message 630 and associated content 650 in other embodiments of the invention. In these embodiments, message 630 selected by message server 520 and delivered to a mobile device includes only a descriptive tag 640, and content 650 associated with message 630 is transmitted to the mobile device only if requested by the mobile device. For example, content 650 may be a 30-second video advertisement stored on the Internet that is preceded by a separate tag 640 having a URL that links to the advertisement. The mobile device may determine admission and output status of message 630 by comparing tag 640 with predetermined policies stored on the mobile device. If message 630 is admitted and stored, the mobile device waits for input by the roaming consumer to request and download content 650.

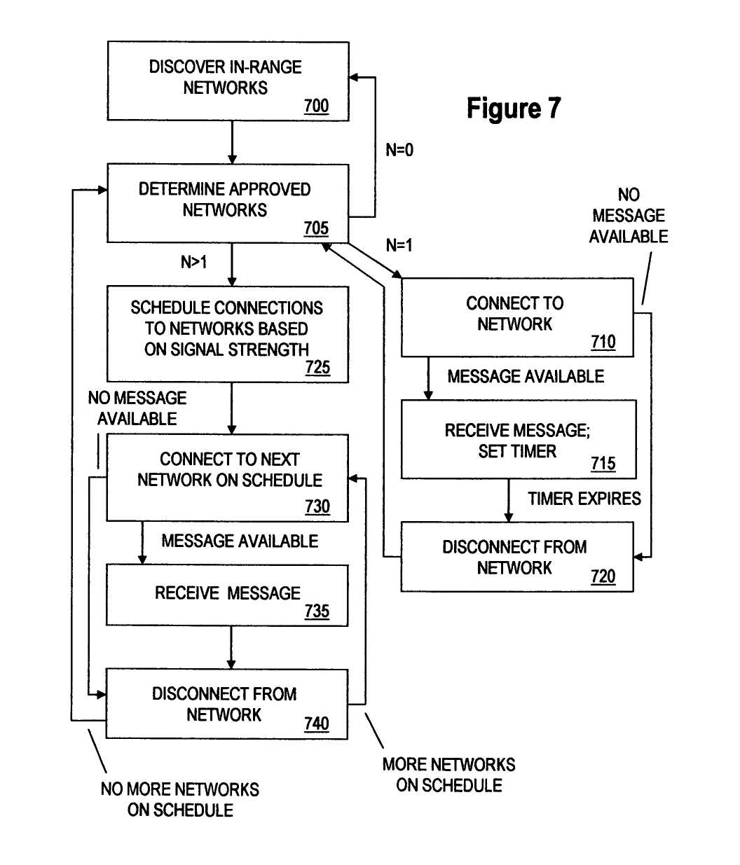

FIG. 7 shows, in some embodiments of the invention, a method by which mobile device 202 receives short-range commercial messages from multiple wireless networks when mobile device 202 is simultaneously in-range of multiple wireless networks. In these embodiments, mobile device 202 connects to the networks sequentially, wherein the sequence is determined based on network signal strength, and receives the short-range commercial messages while connected to the networks. Network signal strength is used to sequence connections as it is generally indicative of proximity of a roaming consumer to the merchant establishment, and a roaming consumer who is closer to the merchant establishment is more likely to receive and act on the short-range commercial message.

In the method of FIG. 7, mobile device 202 first discovers in-range wireless networks (700). For example, wireless communication client 310 listens for Wi-Fi beacons being broadcast by Wi-Fi access points in the vicinity of mobile device 202 and determines security status and RSSI for in-range Wi-Fi networks.

Next, mobile device 202 determines which ones of the in-range wireless networks are approved (705). For example, message client 320 designates in-range Wi-Fi networks that are both unsecured (e.g. not password protected) and surpass a predetermined RSSI threshold as approved, and others as unapproved. If there are no approved networks (N=0), the flow returns to Step 700.

If there is one approved network (N=1), mobile device 202 connects to the approved network (710). For example, wireless communication client 310 performs handshaking with and connects to the approved Wi-Fi network. Then, mobile device 202 receives a short-range commercial message, if one is available, and sets a timer (715). Message client 320 may first receive and respond to an information request from a message source associated with the approved Wi-Fi network by sending a message with the requested information, then determine admission and output status of a short-range commercial message received from the message source via wireless communication interface 220 and set the timer. Then, when the timer expires, mobile device 202 disconnects from the approved network (720) and returns to Step 705. For example, wireless communication client 310 terminates the connection with the approved Wi-Fi network. A timer is set because in the absence of other approved networks there is no need to immediately switch networks to accommodate other short-range commercial messages, and an extended period of connectivity to the approved network may be of value to the merchant and consumer in providing an opportunity for additional information exchange. If there is no short-range commercial message available upon connecting to the approved network, mobile device 202 disconnects from the approved network immediately.

If there are multiple approved networks (N>1), mobile device 202 schedules connections to the approved networks based on network signal strength, wherein networks associated with stronger signals are scheduled earlier (725). For example, message client 320 analyzes the RSSI of each of multiple Wi-Fi beacons received from the multiple in-range Wi-Fi networks and schedules connections to the networks based on RSSI. Then, mobile device 202 connects to the next network on the schedule (730). For example, wireless communication client 310 performs handshaking with and connects to the scheduled Wi-Fi network. Then, mobile device 202 receives a short-range commercial message, if one is available, from the scheduled network (735). For example, message client 320 may first receive and respond to an information request from a message source of the scheduled Wi-Fi network, then determine admission and output status of a short-range commercial message received from the message source via wireless communication interface 220. Then, mobile device 202 disconnects from the network (740). For example, wireless communication client 310 terminates the connection with the Wi-Fi network. Then, mobile device 202 checks whether there are additional networks on the schedule to which mobile device 202 has not yet connected. If so, mobile device 202 returns to Step 730. If not, mobile device 202 returns to Step 700 and re-executes the scheduling algorithm to account for changes in the composition of in-range networks and/or network signal strength that have occurred since the last check.

In some embodiments, network connections may be scheduled based on a comparison of information carried in broadcast beacons [e.g. in a Wi-Fi Service Set Identifier (SSID)] with mobile device user preferences, such as merchant identity, merchant type, content type, product type, and/or financial inducement. For example, connection priority may be assigned based on a match between information carried in an SSID or other identifier of a broadcast beacon, such as “Starbucks” or “free,” with a user preference configured in a mobile device user's favorites list.

In some embodiments, disconnecting from a network is triggered by receipt from the network of an end of message marker or other means for determining that short-range message transmission has been completed.

In other embodiments, a mobile device receives short-range commercial messages attendant to discovery of wireless networks, without having to connect to the networks. In these embodiments, a broadcast beacon that includes a network signal strength indication also includes a short-range commercial message. The short-range commercial message is displayed on a user interface of the mobile device when presenting in-range networks to the roaming comsumer, or stored for later retrieval. For example, a Wi-Fi beacon broadcast by a Wi-Fi access point may include a text advertisement from the merchant who controls the Wi-Fi network in the SSID (e.g. “Joe's Coffee—HALF-PRICE MONDAYS!”). These embodiments do not require handshaking, and thus may offer advantages in terms of the speed at which information is disseminated and reduced system overhead. On the other hand, the ability to individually tailor short-range messages may be impeded in these embodiments.

In still other embodiments, a mobile device is equipped to manage multiple concurrent wireless network connections and connects to and receives short-range messages from multiple networks contemporaneously. In these embodiments, the mobile device includes multiple physical or virtual wireless interfaces and a wireless communication client and message client that can manage multiple concurrent wireless connections. For example, a wireless communication client listens for Wi-Fi beacons being broadcast by Wi-Fi access points in the vicinity of the mobile device and determines security status and RSSI for multiple in-range Wi-Fi networks. Next, the message client designates in-range Wi-Fi networks that are both unsecured and surpass a predetermined network signal strength threshold as approved networks, and others as unapproved networks. Then, the wireless communication client performs concurrent handshaking with, connects to, and receives short-range commercial messages from all approved Wi-Fi networks in parallel. These embodiments do not require connection sequencing and thus may offer advantages in terms of the speed at which information is disseminated and the amount of information disseminated.

While the method of FIG. 7 has been described in conjunction with Wi-Fi networks, the method may operate in conjunction with other wireless networks, such as Bluetooth or RFID networks.

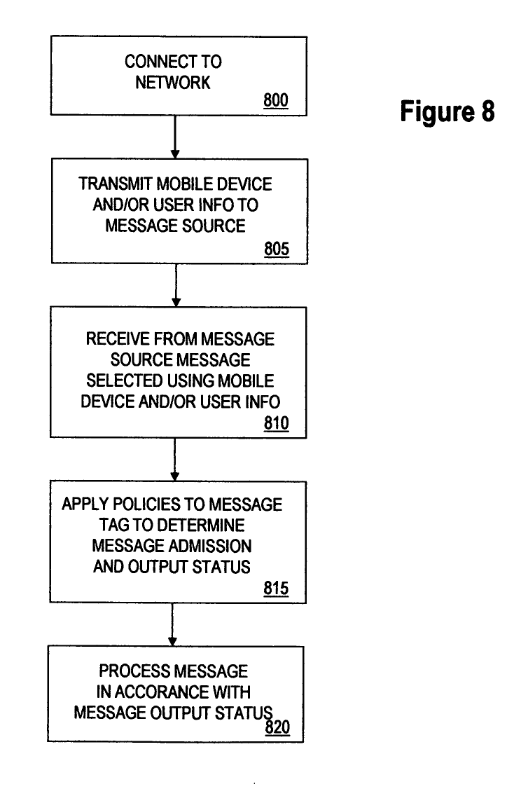

FIG. 8 shows a method by which mobile device 202 processes a short-range commercial message received from a message source in some embodiments of the invention. First, mobile device 202 connects to the network (800). For example, wireless communication client 310 performs handshaking with and connects to an approved Wi-Fi network. Next, mobile device 202 transmits information to a message source associated with the network (805). The information may be transmitted in response to an information request issued by the message source or independent of any request. The information may include, for example, one or more of a unique device identifier [e.g. media access control (MAC) address or electronic serial number (ESN)], device model information, unique user name and/or signal strength information for the approved Wi-Fi network (e.g. RSSI). Message client 320 may retrieve the information from connection information store 340 and transmit the information to the message source.

Next, mobile device 202 receives from the message source a short-range commercial message selected based on the mobile device information, user information and/or signal strength information (810). In some embodiments, the message includes a tag and associated content that are bundled. In other embodiments, the message includes only a tag, and content associated with the message is transmitted to mobile device 202 separately and only if requested by mobile device 202. In either case, the tag precedes the associated content, which allows mobile device 202 to analyze the tag and preemptively discard the short-range message, if warranted, to conserve mobile device 202 processing and memory resources.

In other embodiments, a mobile device does not transmit information to a message source and the message source selects the short-range commercial message independent of any mobile device information. For example, a message source may transmit the same message to all connected devices. Moreover, in some of these embodiments, the message may be transmitted in continuous loop and marked at the end with an end of message marker that informs the various connected mobile devices when the message has ended so that the mobile devices can disconnect from the network at an appropriate time.

Next, mobile device 202 applies predetermined policies to the tag to determine the admission and output status of the short-range commercial message (815). Message client 320 retrieves policies from policy store 350 and compares the policies with information in the tag to determine admission and output status. The comparison may be a keyword comparison (e.g. “sale”, “coffee shop”) or a comparison of numerical descriptors for which there is a standard definition, for example. Admission status determines whether a short-range message will be admitted to mobile device 202 for further processing or preemptively discarded. Output status determines whether an admitted short-range commercial message will be stored on mobile device 202 for later outputting of the associated content or whether the associated content will be outputted on mobile device 202 immediately.

In some embodiments, the policies applied in the admission and output status decisions are predetermined by the roaming user who operates mobile device 202. In these embodiments, the roaming consumer sets policies through inputs on user interface 250 before the short-range commercial message is received. In other embodiments, the policies applied in the admission and output status decisions are set by the mobile device manufacturer (e.g. default policies). In still other embodiments, the policies applied in the admission and output status decisions are set by mobile device 202 based on guidelines input by the roaming consumer through on user interface 250 before the short-range commercial message is received. For example, message client 320 may present the roaming user with a slate of questions on user interface 250 designed to elicit preferences of the roaming consumer and resolve policies based on the roaming user's responses to the questions.

In some embodiments, the policies determine admission and output status of short-range commercial messages based on merchant identity, merchant type, content type, product type, and/or financial inducement. Merchant identity policies determine status based on the identity of the merchant who sourced the message, such as Joe's Coffee, Joann's Bookstore, etc. Merchant type policies determine status based on a goods or services classification for the merchant who sourced the message, such as food/beverage outlet, salon, etc. Content type policies determine status based on a media classification for the message, such as video, audio, etc. Product type policies determine status based on a classification of the goods or services advertised in the message, such as wine, spa treatment, etc. Financial inducement policies determine status based on a classification of the financial inducement advertised in the message, such as free, discount, etc. Policies may also include blanket policies, such as an absorption policy in which all short-range messages are admitted and cached for later outputting; or a policy in which short-range messages comprising Web links to content are admitted and cached but short-range commercial message comprising the content are not. Policies may be input, stored and/or applied in the form of keywords, or in the form of numerical descriptors for which there is a standard definition. Policies may be associated with favorable policy action (e.g. message admission) or unfavorable policy action (e.g. message discard). Moreover, policies may be applied such that a short-range commercial message must meet any operative policy (logical “OR”) or all operative policies (logical “AND”) to receive certain treatment. Purely by way of example, a roaming consumer may establish on mobile device 202 through inputs on user interface 250 a set of policies pursuant to which a short-range commercial message is admitted and outputted immediately only if the message is from a coffee house and offers a free beverage.

In some embodiments, merchant identity policies are managed through a favorites list stored on mobile device 202. A favorites list provides a unified mechanism for a roaming consumer to create and update policies and thereby facilitates policy management. In some embodiments, the favorites list is created and updated online. In these embodiments, the update information is inputted on an Internet capable computer, uploaded to the Internet and downloaded to mobile device 202 from the Internet. The updated information may be disseminated via the Internet to multiple mobile devices operated by the roaming consumer and keep them synchronized. In other embodiments, a favorites list is created and updated via inputs on mobile device 202. In some embodiments, merchant identity policies in a favorites list have different priorities that are associated with different policy actions. Support for different priorities among favorite merchants increases the granularity of policy actions. For example, a message from one of the roaming consumer's very favorite merchants may cause mobile device 202 to admit and output immediately a short-range message whereas a message from one of the roaming consumer's favorite (but not very favorite) merchants may cause mobile device 202 to admit and cache for later outputting the short-range message. A favorites list may be stored in policy store 350.

In some embodiments, the roaming user may through inputs on user interface 250 temporarily disable filtering policies. For example, a roaming consumer shopping in a mall may wish to receive all short-range commercial messages made available during a shopping trip.

In other embodiments, a mobile device may determine admission and/or output status of a short-range commercial message based on real-time consumer input. For example, upon receipt of a short-range commercial message, message client 320 may cause to be outputted on a user interface a query such as “Joe's Coffee has sent you a message. (1) Review Now, (2) Review Later, (3) Discard” and prompt the roaming consumer for a real-time response.

If the short-range commercial message is admitted, mobile device 202 further processes the message in accordance with the determined output status (820). In some embodiments, output status either indicates to output content associated with the message immediately or cache the message for later outputting of the content. Message client 320 causes content associated with messages whose status indicates to output immediately to be outputted on user interface 250 and stores messages whose status indicates to cache for later processing to be stored in message store 330. In other embodiments, output status includes additional or different states, such as cache the message and output an alert selected based on message priority. Alerts may be audible, for example, beep twice on user interface 250 to announce a high priority message and beep once to announce a low priority message; visual, for example, display a red alert on user interface 250 to announce a high priority message, a yellow alert to announce a medium priority message and a green alert to announce a low priority message; or tactile, for example, vibrate twice to announce a high priority message and vibrate once to announce a low priority message.

If the short-range commercial message is not admitted, the message is discarded without further processing (825). In that event, message client 330 drops the message before it enters message store 330 or overwrites or removes the message from message store 330.

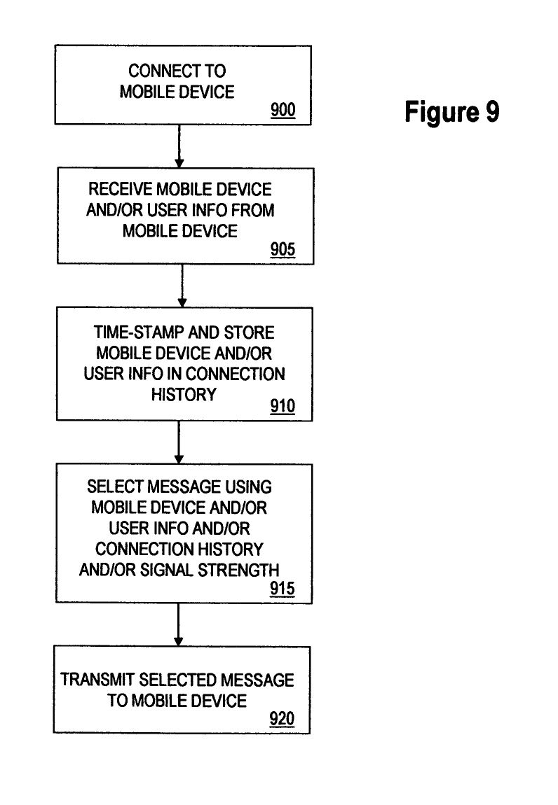

FIG. 9 shows a method by which message source 206 determines a short-range commercial message for delivery to a mobile device in some embodiments of the invention. First, message source 206 receives mobile device information, user information and/or network signal strength information from a mobile device connected to the network (900). The information may be received in response to a request issued by message source 206 or independent of any request. The information may include, for example, one or more of a MAC address, ESN, device model information, a unique user name and/or RSSI. Message server 520 may generate the request for information and transmit it via communication interface 420.

Next, message source 206 stores the mobile device information, user information and/or network signal strength information received from the mobile device (905). Message server 520 stores the information as an associated entry in active connection store 540.

Next, message source 206 selects a short-range commercial message for delivery to the mobile device based on the mobile device information, user information, network signal strength information and/or historical connection information (910). In particular, message server 520 selects the format and content for a short-range commercial message and generates a descriptive tag conformant with the selected message format and content.

Message selection involves dynamic format and content selections from multiple available formats and instances of content. In some embodiments, selectable message formats include a bundled message format wherein the tag and associated content are transmitted contiguously and an unbundled message format wherein the tag is transmitted and the associated content is separately retrievable by the mobile device using information in the tag (e.g. URL). In some embodiments, selectable message content includes a plurality of different video files, audio files, Web pages, short text messages, bar codes and/or banner ads stored in tag/content store 530.

Message server 520 selects a message that is targeted to improve the likelihood that the roaming consumer will act on the message. In particular, message server 520 selects the message based on particular attributes and circumstances of the roaming consumer and his or her mobile device. The selection is informed by one or more of mobile device information, user information, network signal strength information or historical connection information. By way of example, device model information may indicate that a mobile device is incapable of receiving video files, in which case message server 520 selects an audio advertisement in lieu of a video advertisement.

By way of further example, device model information may indicate that a mobile device does not support a particular video file format, in which case message server 520 selects a file format that mobile device supports.

More generally, device model information received from a mobile device may cause a message source to select a short-range commercial message that is compatible with the mobile device.

By way of further example, high network signal strength may indicate that a roaming consumer is inside the merchant's establishment, in which case message server 520 selects an advertisement that is more informational in nature; whereas low network signal strength may indicate that a roaming consumer is outside the establishment, in which case message server 520 selects an advertisement that provides a financial inducement to enter the store.

By way of further example, high network signal strength may indicate that a roaming consumer is likely to remain within range of the network for a substantial period of time, in which case message server 520 selects a full 30-second advertisement; whereas low network signal strength may indicate that a roaming consumer is likely to soon move outside the range of the network, in which case message server 520 selects a Web link to the 30-second advertisement.

By way of further example, a connection history may indicate a pattern of numerous, long-term connections by a mobile device, suggesting that the roaming consumer is a frequent visitor to the store. In that event, message server 520 selects an advertisement that thanks the roaming consumer for his or her patronage.

By way of further example, a connection history may indicate a pattern of connecting by a mobile device Monday through Friday between 7 and 9 a.m. and 5 and 7 p.m., suggesting that the roaming consumer is a passing commuter. In that event, message server 520 selects an advertisement that offers a “commuter special” as an inducement to enter the merchant's establishment.

By way of further example, a connection history may include an indication of short-range messages that have already been sent to the mobile device. Message server 520 selects a message that has not previously been sent to the mobile device to avoid redundancy, which can be the source of annoyance to the roaming consumer.

Next, message source 206 transmits the selected short-range commercial message to the mobile device (915). The message is delivered via communication interface 420 to a base station and relayed by the base station to the mobile device.

Finally, upon termination of the connection by message source 206 or the mobile device, message source 206 updates the connection history (920). Message source 206 maintains in connection history store 550 an historical connection record for each mobile device and/or roaming consumer to which it has been connected. The historical connection record associates a mobile device identifier and/or user identifier with connection times, durations, signal strengths and identifiers of short-range commercial messages sent. Message server 520 locates the appropriate historical connection record in connection history store 550 using the mobile device identifier and/or user identifier received from a mobile device in a current session, consults information from the historical connection record to select an appropriate short-range commercial message for the current session, and updates the historical connection record with information from the current session after the current session is terminated.

It will be appreciated by those of ordinary skill in the art that the invention can be embodied in other specific forms without departing from the spirit or essential character hereof. For example, the short-range messaging systems and methods of the present invention may be found useful by individuals seeking to deliver information from their personal residences to neighbors and passers-by. In this regard, the present invention can provide an interesting alternative to Craigslist in advertising personal items for service or sale. It can also be used by such individuals to communicate upcoming events such as garage sales or engage in political discourse. Moreover, the present invention can be used by government offices, schools, places of worship or other community facilities to transmit public announcements, such as upcoming meetings or safety bulletins. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A mobile device, comprising:
a wireless communication interface; and
a processor communicatively coupled with the wireless communication interface, wherein the mobile device discovers via the wireless communication interface a merchant network, receives via the wireless communication interface on a connection with the merchant network a short-range commercial message selected by the merchant network based on information provided by the mobile device and determines under control of the processor admission status and output status of the short-range commercial message based on one or more policies operative on the mobile device.

2. The mobile device of claim 1, wherein the mobile device discovers via the wireless communication interface a plurality of merchant networks and under control of the processor determines a sequence for establishing connections with the plurality of merchant networks and establishes connections with the plurality of merchant networks in the sequence, wherein the mobile device receives via the wireless communication interface on the sequential connections with the merchant networks short-range commercial messages selected by the merchant networks based on information provided by the mobile device and determines under control of the processor admission status and output status of the received short-range commercial messages based on one or more policies operative on the mobile device.

3. The mobile device of claim 2, wherein the sequence is determined under control of the processor based on a comparison of signal strength indications in broadcast beacons received from the merchant networks.

4. The mobile device of claim 2, wherein the sequence is determined under control of the processor based on a comparison of information in broadcast beacons received from the merchant networks with user preferences configured on the mobile device.

5. The mobile device of claim 4, wherein the comparison comprises a comparison of information in Service Set Identifiers (SSID) with user preferences configured in a favorites list.

6. The mobile device of claim 1, wherein the mobile device discovers via the wireless communication interface a plurality of merchant networks and under control of the processor establishes connections with the plurality of merchant networks concurrently, and wherein the mobile device receives via the wireless communication interface on the concurrent connections with the merchant networks short-range commercial messages selected by the merchant networks based on information provided by the mobile device and determines under control of the processor admission status and output status of the received short-range commercial messages based on one or more policies operative on the mobile device.

7. The mobile device of claim 1, wherein the short-range commercial message comprises a descriptive tag and associated content, and wherein the mobile device receives the descriptive tag prior to receiving the associated content.

8. The mobile device of claim 7, wherein under control of the processor the mobile device applies the policies to the descriptive tag to determine admission status and output status of the short-range commercial message.

9. The mobile device of claim 7, wherein descriptive tag comprises an identity of a merchant providing the short-range commercial message.

10. The mobile device of claim 7, wherein the descriptive tag comprises a type of a merchant providing the short-range commercial message.

11. The mobile device of claim 7, wherein the descriptive tag comprises a type of the associated content.

12. The mobile device of claim 7, wherein the descriptive tag comprises a type of product advertised in the short-range commercial message.

13. The mobile device of claim 7, wherein the descriptive tag comprises a financial inducement advertised in the short-range commercial message.

14. The mobile device of claim 7, wherein the descriptive tag comprises a Web link to the associated content.

15. The mobile device of claim 1, wherein the policies comprise a merchant identity policy.

16. The mobile device of claim 1, wherein the policies comprise a merchant type policy.

17. The mobile device of claim 1, wherein the policies comprise a content type policy.

18. The mobile device of claim 1, wherein the policies comprise a product type policy.

19. The mobile device of claim 1, wherein the policies comprise a financial inducement policy.

20. The mobile device of claim 1, wherein the determined output status indicates immediate outputting of the message.

21. The mobile device of claim 1, wherein the determined output status indicates caching of the message for later outputting.

22. The mobile device of claim 1, wherein the determined output status indicates caching of the message for later outputting and outputting an alert selected based on a priority of the short-range commercial message.

23. The mobile device of claim 1, wherein the information provided by the mobile device comprises a mobile device identifier.

24. The mobile device of claim 1, wherein the information provided by the mobile device comprises mobile device model information.

25. The mobile device of claim 1, wherein the information provided by the mobile device comprises a user name.

26. The mobile device of claim 1, wherein the information provided by the mobile device comprises a signal strength indication.

27. The mobile device of claim 1, wherein the connection is an Institute of Electrical and Electronics Engineers Standard 802.11 (Wi-Fi) connection.

28. A mobile device, comprising:
a wireless communication interface;
a user interface; and
a processor communicatively coupled with the wireless communication interface and the user interface, wherein the mobile device discovers via the wireless communication interface a merchant network and under control of the processor displays on the user interface a short-range commercial message received via the wireless communication interface attendant to discovery of the merchant network without establishing a connection with the merchant network.

29. The mobile device of claim 28, wherein the short-range commercial message is carried in a SSID of a Wi-Fi beacon received from the merchant network.

30. A short-range messaging system, comprising:
a base station; and
a message source communicatively coupled with the base station, wherein the base station establishes a wireless connection with a mobile device and the message source transmits on the connection to the mobile device a short-range commercial message selected by the message source based on information received on the connection from the mobile device, wherein the message source and the base station are collocated within a merchant establishment and the message source communicates with the mobile device independent of the Internet.

31. The system of claim 30, wherein the message source locates a connection history of a user based on the information received on the connection from the mobile device and selects the short-range commercial message based on the connection history.

32. The system of claim 30, wherein the message source locates historical connection times of a user based on the information received on the connection from the mobile device and selects the short-range commercial message based on the historical connection times.

33. The system of claim 30, wherein the message source locates historical connection durations of a user based on the information received on the connection from the mobile device and selects the short-range commercial message based on the historical connection durations.

34. The system of claim 30, wherein the message source locates historical signal strengths of connections made by a user based on the information received on the connection from the mobile device and selects the short-range commercial message based on the historical signal strengths of connections.

35. The system of claim 30, wherein the message source locates a history of messages sent to a user based on the information received on the connection from the mobile device and selects the short-range commercial message based on the message history.

36. The system of claim 30, wherein the message source locates a connection history of the mobile device based on the information received on the connection from the mobile device and selects the short-range commercial message based on the connection history.

37. The system of claim 30, wherein the message source locates historical connection times of the mobile device based on the information received on the connection from the mobile device and selects the short-range commercial message based on the historical connection times.

38. The system of claim 30, wherein the message source locates historical connection durations of the mobile device based on the information received on the connection from the mobile device and selects the short-range commercial message based on the historical connection durations.

39. The system of claim 30, wherein the message source locates historical signal strengths of connections made by the mobile device based on the information received on the connection from the mobile device and selects the short-range commercial message based on the historical signal strengths of connections.

40. The system of claim 30, wherein the message source locates a history of messages sent to the mobile device based on the information received on the connection from the mobile device and selects the short-range commercial message based on the message history.

41. The system of claim 30, wherein the information received on the connection from the mobile device comprises an indication of signal strength and the mobile device selects the short-range commercial message based on the indication of signal strength.

42. The system of claim 30, wherein the short-range commercial message comprises a descriptive tag and associated content, and wherein the message source transmits the descriptive tag prior to transmitting the associated content.

43. The system of claim 42, wherein descriptive tag comprises an identity of a merchant providing the short-range commercial message.

44. The system of claim 42, wherein the descriptive tag comprises a type of a merchant providing the short-range commercial message.

45. The system of claim 42, wherein the descriptive tag comprises a type of the associated content.

46. The system of claim 42, wherein the descriptive tag comprises a type of product advertised in the short-range commercial message.

47. The system of claim 42, wherein the descriptive tag comprises a financial inducement advertised in the short-range commercial message.

48. The system of claim 42, wherein the descriptive tag comprises a Web link to the associated content.

49. The system of claim 30, wherein the information provided by the mobile device comprises a mobile device identifier.

50. The system of claim 30, wherein the information provided by the mobile device comprises mobile device model information.

51. The system of claim 30, wherein the information provided by the mobile device comprises a user name.

52. The system of claim 30, wherein the information provided by the mobile device comprises a signal strength indication.

53. The system of claim 30, wherein the connection is a Wi-Fi connection.

54. The system of claim 30, wherein the base station and the message source comprise discrete network nodes.

55. The system of claim 30, wherein the base station and the message source comprise a single network node.

56. The system of claim 30, wherein the mobile device selects the short-range commercial message based on compatibility of the short-range commercial message with the mobile device.

57. The system of claim 30, wherein the merchant establishment is a permanent establishment.

58. The system of claim 30, wherein the merchant establishment is a temporary establishment.

59. A short-range messaging system, comprising:
a base station; and
a message source communicatively coupled with the base station, wherein the base station establishes a wireless connection with a mobile device and the message source transmits on the connection to the mobile device a short-range non-commercial message selected by the message source based on information received on the connection from the mobile device, wherein the message source and the base station are collocated within a non-merchant establishment and the message source communicates with the mobile device independent of the Internet.

60. The system of claim 59, wherein the non-merchant establishment is a personal residence.

61. The system of claim 59, wherein the non-merchant establishment is a community facility.

62. The system of claim 59, wherein the non-commercial message is a public announcement.

63. The system of claim 59, wherein the non-commercial message is a political announcement.
